(19) United States
(12) Patent Application Publication
(10) Pub. No.: US 2012/0085466 A1
(43) Pub. Date: Apr. 12, 2012

(54) Method For Producing A Steel Component By Hot Forming And Steel Component Produced By Hot Forming

(75) Inventors: Barbara Lupp, Dortmund (DE); Ansgar Albers, Recklinghausen (DE); Sabine Hasenfuß, Stuttgart (DE); Matthias Kimpel, Schwelm (DE); Manfred Meurer, Rheinberg (DE); Wilhelm Warnecke, Hamminkeln (DE); Michael Steinhorst, Essen (DE)

(73) Assignee: THYSSENKRUPP STEEL EUROPE AG, Duisburg (DE)

(21) Appl. No.: 13/147,006

(22) PCT Filed: Feb. 1, 2010
(86) PCT No.: PCT/EP2010/051175

§ 371 Date: Dec. 22, 2011

(30) Foreign Application Priority Data
Feb. 6, 2009 (DE) 10 2009 007 909.2

(51) Int. Cl. C21D 8/02; B32B 15/04; C21D 6/00; C23C 8/00; B32B 15/01

(52) U.S. Cl. 148/241; 148/240; 148/400

(57) ABSTRACT

A method for producing a steel component provided with a metallic coating which protects against corrosion, in which a steel flat product, produced from an alloyed heat-treated steel, is coated with an Al coating which contains ≧85% wt. Al and optionally ≦15% wt. Si, a Zn coating with ≧90% wt. Zn, and a top layer, the main constituent of which is at least one metal salt of phosphoric acid or diphosphoric acid and which additionally can contain contents of up to 45% of an Al:Zn ratio as well as optionally metal oxides, metal hydroxides and/or sulphur compounds, the steel flat product is heat treated at ≧750° C., and the steel component is hot-formed from the heated steel flat product. The hot-formed steel component is cooled at a cooling rate sufficient to form a tempered or martensitic structure.

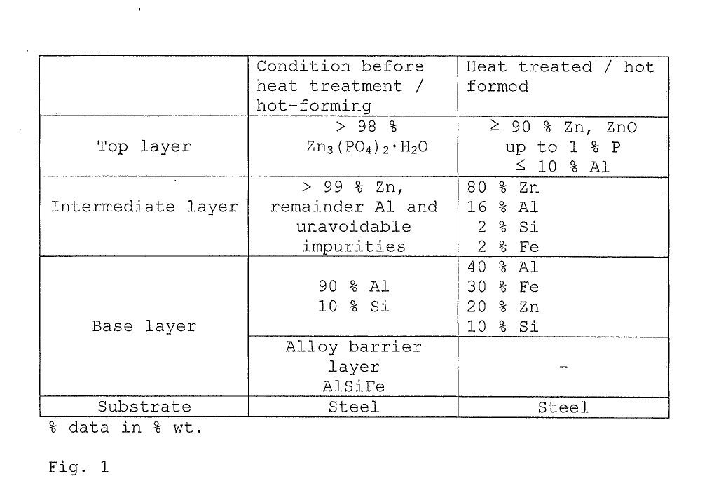

The invention relates to a method for producing a steel component provided with a metallic coating which protects against corrosion, in particular by means of a cathodic protective effect, by hot forming a steel flat product produced from an alloyed, in particular low-alloy heat-treated steel.

In addition, the invention relates to a steel component produced by hot forming a steel flat product and provided with a metallic corrosion protection coating which protects against corrosion, in particular by means of a cathodic protective effect.

When steel flat products are mentioned here, what are meant are steel strips, steel sheets or blanks obtained from these, as well as the steel substrate of the steel component obtained from such strips, sheets or blanks.

Currently, in vehicle construction, increasingly demanding requirements are being set for the rigidity and strength of components. At the same time, however, a body weight which is as low as possible and correspondingly narrow material thicknesses are being aimed for in the interest of optimising the energy consumption required for driving the respective vehicle. These at first sight contradictory requirements can be fulfilled by high-strength and ultra high-strength steel materials which by applying suitable process steps permit the production of components having a very high strength with a narrow material thickness.

A method which permits the production of correspondingly high-strength and, at the same time, thin-walled steel components is hot-press hardening. In hot-press hardening, firstly a blank is cut from a steel strip. This blank is then heated to a hot-forming temperature which generally is above the Ar3 temperature of the steel material being processed in each case. The blank heated in this way is then placed in the heated state into a forming tool and therein made into the component shape desired. Subsequently or meanwhile, the formed component is cooled, in which a tempered or martensitic structure forms in the processed steel.

Low-alloy steels are considered for press mould hardening. However, these steels are sensitive to corrosive attack, to which they are particularly exposed when they are used for the construction of vehicle bodies.

More recently, various attempts have been made to make it possible for the advantages of hot forming high-strength steels which are suitable for hot-press hardening to be directly used for these areas of application too. The prior art described in EP 0 971 044 B1 must be cited as a precursor to this development. According to this known method, a hot-rolled steel sheet is processed which besides iron and unavoidable impurities contains (in % wt.) between 0.15-0.5% C, between 0.5-3% Mn, between 0.1-0.5% Si, between 0.01-1% Cr, less than 0.2% Ti, in each case less than 0.1% Al and P, less than 0.05% S and between 0.0005-0.08% B. The steel made according to this specification is in practice known by the name 22MnB5.

The steel strip made in this way is provided with a coating according to EP 0 971 044 B1, which is based on aluminium or an aluminium alloy. In particular, this coating is an AlSi coating which has Fe contents. The steel strip coated in this way is heated to a temperature of more than 750° C., formed into a component and then cooled at a cooling rate at which a martensitic structure forms.

The steel component produced in the way known from EP 0 971 044 B1 exhibits, in addition to good strength properties, fundamentally good resistance to corrosion. At the Same time, steel components can be produced from the steel sheets provided according to this prior art in only one, single hot-forming step without the Al coating becoming damaged.

The steels processed in the known way and provided with an Al-based coating lack one significant property which cathodically protects the steel against corrosion when damaged. This susceptibility has proved a problem in particular when using the steels processed according to the known method for car bodies in the automotive industry.

In order to eliminate this disadvantage, it has been proposed in WO 2005/021820 A1, WO 2005/021821 A1 and WO 2005/021822 A1 in each case to apply onto the steel substrate a coating based on zinc instead of an Al-based coating. Although sheet steel components produced from steel flat products coated in this way do have cathodic corrosion protection, it has to be accepted that the deforming of the respective steel flat product into the component has to be carried out in at least two stages, wherein the first stage is a cold deformation, in which the greatest part by far of the forming operation is carried out and in the course of the hot deformation stage only one more calibration of the component is possible followed by quenching. This results in this known process only being able to be used to a limited extent commercially.

An alternative attempt to enable components produced from steels of the kind described in EP 0 971 044 B1 to be used more effectively for use in car body construction is described in DE 103 33166 A1. According to the method known from this published application, a steel component is produced in a way known from EP 0 971 044 B1 and subsequently coated with an additional zinc layer. Although the problem of cathodic corrosion protection is solved by means of this subsequent, single piece galvanizing, an additional, subsequent coating step has to be accepted for that purpose, which not only leads to an increased expenditure of time in producing body components but also to increased costs.

Against the background of the previously explained prior art, the object forming the basis of the invention was to specify an economic method for producing high-strength steel components, in which, on the one hand, optimum deformation behaviour of the coating during hot-press forming of the respective steel flat product is guaranteed and in which, on the other hand, the steel components obtained have optimum corrosion protection which make them particularly suitable for use in car bodies. In addition, a correspondingly constituted steel component should be created.

With regard to the method, this object is achieved according to the invention by performing the production steps specified in claim 1 when producing a steel component. Advantageous embodiments of this method are specified in the claims referring back to claim 1.

With regard to the steel component, this object is achieved according to the invention by such a steel component being formed according to claim 25. Advantageous embodiments of this component are mentioned in the claims dependent on claim 25.

According to the invention, a metallic coating is produced on a steel flat product produced from a low-alloy heat-treated steel, which metallic coating is formed from three layers applied in three process steps following one after another. The heat-treated steel, from which the steel flat product is produced, can be, for example, a manganese-boron steel, as it is already used in many cases in the prior art.

According to the invention, in the first production step a) the steel flat product, produced from the heat-treated steel constituted in a suitable manner, is coated with an Al coating which contains at least 85% wt. Al, in particular 90% wt., wherein additionally contents of up to 15% wt. can be present in the Al coating applied according to the invention. Typical variants of the Al coating applied according to the invention are a coating consisting almost entirely of Al or an AlSi variant, in which the Si content of the AlSi coating applied is 5-12% wt. Si, in particular 8-12% wt.

Subsequently, a Zn coating is applied onto this Al coating which consists of at least 90% wt., in particular 95% wt. of zinc (production step b)).

In a production step c), finally the steel flat product, provided with the Al coating and the Zn coating lying on it, is coated with a top layer, the main constituent of which is at least one metal salt of phosphoric acid or diphosphoric acid, and which additionally can contain contents of up to 45% of an Al:Zn ratio, wherein Al takes up 0.1-99.9% wt. of this ratio and Zn the respective remaining amount, or compounds of Al and Zn, as well as optionally metal oxides, metal hydroxides and/or sulphur compounds. Additionally, up to 2% wt. sulfides of the metal ions present in the phosphate can be present.

Before the steel flat product is conveyed for further processing, after coating has taken place there is consequently a coating on a steel flat product, coated according to the invention, which has a base layer consisting of at least 85% aluminium, an intermediate layer, essentially consisting of zinc and lying on the base layer, and a top layer applied onto it which predominantly consists of a metal phosphate.

The metal phosphate, present in the form of a metal salt of phosphoric acid or diphosphoric acid in the top layer applied onto the Zn layer, can basically be formed by a metal from the group “Cu, Mo, Fe, Mn, Sb, Zn, Ti, Ni, Co, V, Mg, Bi, Be, Al, Ce, Ba, Sr, Na, K, Ge, Ga, Ca, Cr, In, Sn”, wherein the elements “Zn, Al, Ni, Mn, Mg, Bi, Cu, Si, Mo” are particularly suited. Particularly good properties arise in the top'layer if the metal phosphate is formed by a metal belonging to the group “Zn, Fe, Mn, Ni, Mo, Mg”. If this proves to be beneficial two or more metal phosphates in combination with one another can also be contained in the top layer.

Before being hot formed into the respective component, the steel flat product coated with at least three layers in such a way is then, in a production step d), heat treated at a heat-treatment temperature which is at least 750° C. In the course of this heat treatment a metallic coating materialises, as a result of diffusion processes taking place during the heat treatment, which consists of a base layer, typically predominantly consisting of AlFeZnSi and lying on the substrate, of which the greatest proportion is Al, but Fe, Zn and Si also emerge as significant constituents.

An intermediate layer, typically predominantly consisting of ZnAl(Fe,Si), lies on the base layer of the coating obtained after the heat treatment.

The intermediate layer is, in turn, covered by a top layer which consists of zinc and amorphous phosphates or the thermal decomposition products thereof, wherein typically 0.1-45% wt. Zn is contained in the surface remote from the steel flat product, as well as crystalline residual amounts of phosphates.

In the case of the finish-formed component, the top layer contains'zinc which has diffused from the intermediate layer into the top layer and has formed ZnO there. Correspondingly, the top layer in practice consists particularly predominantly of amorphous and crystalline diphosphates and zinc oxide and/or aluminium oxide.

If the top layer applied in production step c) contains a Zn phosphate (Zn₃(PO₄)₂), an Fe phosphate or an Mn phosphate as the metallic phosphate, then after the heat treatment (production step d) the top layer present on the steel flat product prepared for hot deformation consists predominantly of ZnO, Zn, (Zn₃(PO₄)₂, Fe, FeO, Al. These are usually in crystalline form, but can also have amorphous structures dependent on the temperature profile of the heat treatment.

The heat-treated steel flat product is, if necessary, in a separate production step e) heated to the hot-forming temperature, starting from which the subsequent hot forming is carried out. The hot-forming temperature is also at least 750° C. It is thereby the case both for the heat-treatment temperature and for the hot-forming temperature that they are typically in the range from 800-950° C., in particular 800-910° C. or 820-890° C. under the conditions relevant in practical application.

The duration of the heat treatment provided according to the invention is in the range from 30-720 seconds dependent on the furnace technology available in each case and the geometry of the steel flat product, wherein a heat-treatment duration of 60-360 seconds has proved to be particularly suitable for practical application.

A variant of the invention, which is particularly cost-effective and can be carried out with reduced technical effort, is characterised in that the heat treatment (production step d)) and the heating of the steel flat product to the hot-forming temperature (production step e)) are carried out combined in one common production step. This is particularly valid taking into account the fact that the coating, produced according to the invention on the steel flat product before hot forming, materialises during heat treatment which is carried out in the temperature range in which the hot-forming temperature also typically lies.

The steel flat product heated to the hot-forming temperature is hot formed into the respective component in a further production step f) in a way known per se.

The steel component obtained by hot forming is finally cooled in such a way that it is thereby guaranteed that the desired tempered or martensitic structure results in the component.

The production steps listed previously are the procedures which are at least required to achieve the success obtained according to the invention. Of course, additional steps can be provided if this proves necessary from the production-related point of view.

In this way, for example, splitting the flat product, present as strip beforehand and coated with two layers in the way according to the invention, into blanks can precede heating to the hot-forming temperature. Moreover, cleaning the surface of the steel flat product, and the coating applied onto it, can in each case precede the individual coating steps.

Surprisingly, it has firstly been shown that the steel flat product coated in the way according to the invention can be formed without any difficulty into a steel component. Thus, steel flat product coated according to the invention has proved itself suitable both for a direct hot-forming operation, i.e. carried out as a single-stage production step without the preceding cold deformation, and for an indirect, i.e. at least two-stage, forming operation characterised by cold deformation followed by hot deformation. After the hot-forming operation, carried out in each case, with a steel component according to the invention a zinc-alloyed surface having a zinc content of at least 60% wt., in particular at least 80% wt. is present. Cathodic corrosion protection results from this, which can be proved electrochemically in unequivocal terms. Thus, in the accelerated corrosion test (salt spray mist test) it can be proved that coatings produced according to the invention have a resistance to corrosion which is comparable to pure zinc coatings.

Additional advantages arise in relation to corrosion protection from the fact that up to 30% Al can be present in the intermediate layer of the steel component obtained according to the invention.

The base layer of the total metallic coating produced according to the invention, which base layer has a high proportion of Al and is arranged between the Zn dominated top layer and the respective steel substrate, protects this coating from an excessive diffusion of zinc and iron during the heat treatment at the heat-treatment and hot-forming temperatures chosen according to the invention. Advantages of the barrier effect of the base layer are, on the one hand, delayed red rust formation on the surface and, on the other hand, the base layer preventing zinc from being able to reach the grain boundaries of the steel substrate, which would result in the risk of crack formation during hot forming. The Al—Fe—Zn—Si containing base layer of the total coating produced according to the invention in addition protects the steel substrate particularly effectively against oxidation with the ambient oxygen.

During hot forming, the top layer produced on the steel flat product according to the invention has a special importance. During hot forming, this layer as a “functional layer” causes a separation between the layers of the coating produced according to the invention which lie below it and the surfaces of the tool which the steel flat product comes into contact with when it is hot formed into the steel component. In this way, it reliably prevents excessive abrasion of coating material in the forming tool and thus eliminates local welded joints between the component and the tool, which otherwise could impair the manufacturing result or damage the tool.

In addition—and this was particularly surprising—the top layer present on the steel flat product, processed according to the invention, when it enters the hot-forming tool particularly effectively reduces the risk of cracks forming which otherwise could form in the coating layer in the course of hot forming and would impair its corrosion-protective effect.

The steel component produced according to the invention accordingly has increased corrosion resistance compared to conventionally produced components and significantly improved frictional properties during cold deformation which, where appropriate, is subsequently carried out on it. Moreover, the top layer present on the steel component according to the invention guarantees particularly good paint adhesion. Furthermore, the coating present on a steel component produced according to the invention is considerably better suited for resistance spot welding compared to the prior art.

With the approach according to the invention, a particularly commercially feasible opportunity is thus provided for producing components, which are corrosion-protected in an optimum way, from high-strength, hot-press formable steels, which have a property profile which is optimised for their further processing.

A steel component obtained in the way according to the invention, following the previously summarised findings, comprises a metallic coating which is formed by a base layer lying on the steel flat product, by an intermediate layer lying on the base layer and by a top layer lying on the intermediate layer, wherein the base layer contains at least 30% wt. Al, at least 20% wt. Fe, at least 3% wt. Si and at most 30% wt. Zn, wherein the intermediate layer contains at least 60% wt. Zn, at least 5% wt. Al, up to 10% wt. Fe and up to 10% wt. Si, and wherein the top layer contains at least 8% wt. Zn, as well as ZnO, P and Al, wherein the P content is at most 1% wt. and the main constituent of the top layer is ZnO. In practice it emerges that the top layer regularly predominantly consists of amorphous and crystalline diphosphates and zinc oxide and/or aluminium oxide.

The Al coating can be applied by hot-dip aluminizing as the first coating layer onto the respective steel flat product particularly economically and with an optimum coating effect at the same time.

The Zn coating can then be applied by hot-dip galvanizing onto the Al layer, which was previously applied onto the steel flat product, also particularly economically in a comparable way known per se and proven and tested in practice.

Particularly successful coating results can, moreover, be obtained if the Zn coating, as an alternative to hot-dip galvanizing, is deposited electrolytically on the Al coating. With electrolytic galvanizing, preferably a layer having a Zn content of at least 99% wt. is deposited.

A further alternative possibility for applying the Zn layer is depositing the Zn coating on the Al coating in a PVD process. The use of the PVD process (PVD=Physical Vapour Deposition) for applying the Zn layer permits the thickness of the layer to be set particularly precisely.

Particularly in the cases where the Zn layer is applied by hot-dip galvanizing and by means of the PVD process, in addition to Zn at least one further element from Al, Mg or Fe can be included. Advantageously, the contents of 5% wt. Al, 5% wt. Mg and/or 0.5% wt. Si should not be exceeded.

The contents of further accompanying elements in the Zn coating, such as e.g. Pb, Bi, Cd, Ti, Cu, Cr or Ni, should not in total exceed 1% wt.

The top layer, applied onto the Zn layer in production step c) according to the invention and having at least one metal phosphate, can be applied by spray coating or dip coating (e.g. carried out as bi-cation or tri-cation phosphating).

Alternatively, the top layer can also be applied onto the Zn layer by means of a no-rinse process. In the course of this process, the metal surfaces are cleaned in a first stage. Possible residues of chemicals from this first stage are then removed by rinsing with water. The metal surface cleaned in this way is wetted with a predominantly aqueous solution, which, however, is not rinsed any more, but dried in situ on the metal surface and there converted into a solid film of the bath constituents of the predominantly aqueous solution. Such a no-rinse process can be carried out on a phosphate basis, with an organic proportion or on a silicate basis to produce the top layer according to the invention.

It is also possible to deposit the top layer by vapour deposition or to apply it by means of a gel/sol mist. In the course of these processes, amorphous and/or crystalline phases are deposited on the Zn coating.

The phosphate containing top layer according to the invention can also be produced on the Zn coating in a way which is particularly suitable for practical application by carrying out a corresponding phosphate treatment within an electrolytic coating line, within which beforehand the Zn layer has already been applied onto the Al-based base layer of the coating produced according to the invention.

In order to adjust a surface roughness, improving the wettability and binding of the Zn layer applied subsequently, it can be advantageous to subject the steel flat product provided with the Al coating to skin-pass rolling before the Zn coating is applied.

For the same purpose, it can be advantageous to pickle the steel flat product, provided with the Al coating, before the Zn coating is applied. With pickling, the flat products coated according to the invention are routed through an acid bath which rinses off the oxide layer from them without attacking the surface of the steel flat product itself. By means of the pickling step carried out in a targeted manner, the oxide removal is controlled, so that a surface is obtained which is advantageously adjusted for electrolytic strip galvanizing.

In some cases, in particular when carrying out the production steps in a discontinuous way, it is advantageous to additionally carry out alkaline cleaning before the pickling.

The method according to the invention can be carried out particularly economically if the Al coating, subsequently the Zn coating and then the metal phosphate containing top layer and all production steps required between the respective coating steps are completed in a sequence of operations which are performed following continuously one after the other. A typical process flow of such an in-line coating production comprises then the following production steps:
Cleaning the steel substrate,
Annealing the cleaned steel substrate,
Melt bath coating the steel substrate with the Al layer (base layer, production step a)),
Skin-pass rolling the steel flat product coated with the Al base layer,
Pickling the skin-pass rolled steel flat product,
Electrolytically coating the pickled steel flat product with the Zn layer (intermediate layer, production step b)),
Applying and forming the metal phosphate containing top layer onto the Zn layer in the course of a phosphate treatment which is carried out in the electrolytic coating line.

If a corresponding manufacturing technology is not available, or if it proves advantageous for special reasons, then it also possible, however, to apply the Al coating and subsequently the Zn coating in a broken, discontinuous operation without difficulty.

The particular advantage of the invention, as already mentioned, is that the steel flat product can be formed into the steel component in a single hot-forming step. Thus, steel strip coated according to the invention proves to be particularly unsusceptible to the stresses and strains occurring in a pass during hot forming, even when the respective component obtains a complex form.

It is also, however, equally possible to carry out forming of the flat product coated according to the invention in multiple stages, wherein in each case at least one forming stage is carried out as a hot-forming step which follows on from heating to hot-forming temperature. Correspondingly, when this proves advantageous from the production-related point of view, the steel flat product can pass through at least one cold-forming step before heating to the hot-forming temperature. In doing so, deformation can almost completely take place during cold forming, so that in this case the hot-forming step carried out after cold forming rather acts in the tool as a hot-calibration step with subsequent quenching.

Particularly good production results occur if the application of the individual layers of the coating produced according to the invention is carried out such that before the heat treatment the Al coating applied onto the steel flat product has a thickness of 5-30 μm, in particular 10-30 μm, the Zn coating applied onto the AlSi coating has a thickness of 2-10 μm and the metal phosphate containing top layer lying on the Zn layer has a coating weight of 50 mg/m² to 5 g/m², in particular 0.2-2 g/m².

Tests have shown thereby that, especially if the AlSi coating is applied by hot-dip aluminizing, before heating to the heat treatment temperature a 2-10 μm thick, in particular a 2-5 μm thick, alloy barrier layer containing Al, Si and Fe is present between the steel flat product and the correspondingly applied AlSi coating, on which alloy barrier layer a 5-20 μm thick AlSi containing layer lies. By taking the previously mentioned thicknesses of its individual layers into account, a metallic coating applied according to the invention in at least three production steps onto the flat product to be deformed typically has a total thickness of 5-100 μm, in particular 15-70 μm.

At the end of the heat treatment, i.e. on entry into the respective hot-forming tool, a coating is then present on a steel flat product, coated according to the invention, which is composed of a 10-35 μm thick base layer, a 3-10 μm thick intermediate lying on it and a 0.01-10 μm, in particular a 0.01-3 μm, thick top layer.

The invention will be explained in more detail below by means of an exemplary embodiment.

A cold-rolled steel strip was produced from a temperable steel, for example from the known 22MnB5 steel, in a way known per se by casting a correspondingly composed steel melt into a slab or thin slab, hot rolling the respective slab into a hot strip, coiling the hot strip and cold rolling the hot strip in a conventional way, wherein, in addition to the above mentioned production steps, if necessary additional production steps were carried out, such as annealing and pickling the hot strip obtained after hot rolling or annealing the cold strip.

The cold-rolled steel strip obtained in this way was fed into a continuously operating hot-dip coating line, passing through the individual work stations thereof in a continuous, consecutive sequence. In the hot-dip coating line, the cold-rolled steel strip firstly had the dirt residues, which remained on it from the cold-rolling process, removed in a cleaning section. Then, the cleaned steel strip passed through an annealing furnace, in which it was heated to a temperature of 750° C. and annealed in a re-crystallising way under a protective gas atmosphere consisting of 10% vol. H² and remainder N². Still under the protective gas atmosphere, the annealed steel strip was then cooled to a temperature of 680° C. and dipped into an aluminium bath the temperature of which was 660° C. In addition to Al and unavoidable impurities, the aluminium bath contained 10% silicon.

After withdrawing the steel strip from the melt bath, the thickness of the AlSi coating layer now present on the steel strip was set to 20 μm by means of a jet wiping system, which forms the base layer of the coating to be produced on the steel strip.

Then, the steel strip provided with the AlSi coating layer was cooled to less than 50° C.

The cooled steel strip was then subjected to skin-pass rolling, in order to set the surface roughness of the AlSi coating layer.

In a subsequent section, the steel strip which had been skin-pass rolled was subjected to a pickling treatment, in which it was firstly given an alkaline pre-treatment using NaOH and subsequently had the oxidic residues adhering to it removed in an aqueous solution with 80 g/l HCl for 5 s at 40° C. Then, the strip was rinsed using completely demineralised water.

Afterwards, electrolytic deposition of a 5 μm thick zinc layer forming the intermediate layer of the coating to be produced and consisting of a zinc sulphate electrolyte took place in electrolysis cells at a current density of 50 A/m² and an electrolyte temperature of 60° C. on the surface of the Al coating layer produced beforehand.

In a further process step, a 50° C. hot phosphate solution with the main cations Zn, Mn and Ni was applied onto the Zn coating layer by means of a spray application. Inorganic conversion layers with a layer weight of 0.5 g/m², which formed the top layer of the coating to be produced, resulted from this application.

The strip, provided way with an at least three-layered coating in this way, was wound into a coil for onward movement to the subsequently passed through hot-forming line.

Blanks were firstly cut from the coated steel strip at the beginning of the hot-forming line.

In a process carried out in one stage, in which the coating was heat treated combined with heating to the temperature required for hot forming the blank, the blanks were then heated in a furnace and held at this temperature for five minutes. The temperature of the heat treatment and the hot-forming temperature required for hot forming were the same and were in each case 880° C. The duration of the heat treatment was designed in such a way that the steel blank was heated through to the hot-forming temperature at the end of the heat treatment.

The figure shows a comparison of the layer construction of the coating produced on the steel flat product coated in the above described way before and after the heat treatment.

The blanks exiting the furnace were conveyed by means of a manipulator into a hot-forming press, in which they were hot-press formed into a steel component in a way known per se. The steel components obtained were then cooled quickly in such away that a martensitic structure formed and the required strength values were obtained.

1. A method for producing a steel component provided with a metallic coating which protects against corrosion, comprising the following production steps:
a) coating a steel flat product, produced from an alloyed heat-treated steel, with an Al coating comprising at least 85% wt. Al and optionally up to 15% wt. Si;
b) coating the steel flat product provided with the Al coating with a Zn coating comprising at least 85% wt. Zn;
c) coating the steel flat product, provided with the Al coating and the Zn coating lying on it, with a top layer comprising a main constituent of at least one metal salt of phosphoric acid or diphosphoric acid;
d) heat-treating the steel flat product at a heat-treating temperature which is at least 750° C.;
e) heating the steel flat product to a hot-forming temperature;
f) hot-forming the steel component made from the heated steel flat product; and
g) forming a finish-formed steel component by cooling the hot-formed steel component at a cooling rate which is sufficient to form a tempered or martensitic structure.

2. The method according to claim 1, wherein the steps of heat-treating the steel flat product and heating the steel flat product to a hot-forming temperature are carried out in a common production step.

3. The method according to claim 2, wherein the heat-treating temperature is at most equal to the hot-forming temperature.

4. The method according to claim 1, wherein the heat-treating temperature is in the range from 800-950° C.

5. The method according to claim 1, wherein the hot-forming temperature is in the range from 800-950° C.

6. The method according to claim 1, wherein the Al coating is applied by hot-dip aluminizing.

7. The method according to claim 1, wherein the Al coating contains 5-12% wt. Si.

8. The method according to claim 1, wherein before heating the steel flat product to the hot-forming temperature, the Al coating is applied onto the steel flat product in a thickness of 5-25 μm.

9. The method according to claim 1, wherein the Zn coating is applied by hot-dip galvanizing onto the Al layer which was previously applied onto the steel flat product.

10. The method according to claim 1, wherein the Zn coating is deposited on the Al coating electrolytically.

11. The method according to claim 1, wherein the Zn coating is deposited on the Al coating in a PVD process.

12. The method according to claim 1, wherein the Zn coating contains at least 190% wt. Zn.

13. The method according to claim 1, wherein at least one element from the group consisting of Al, Mg, Ni, and Si is also contained in the Zn coating.

14. The method according to claim 1, wherein before heating the steel flat product to the hot-forming temperature, the Zn coating is applied onto the Al coating in a thickness of 2-10 μm.

15. The method according to claim 1, wherein before heating the steel flat product to the hot-forming temperature, a 2-5 μm thick alloy barrier layer containing Al, Si and Fe is present between the steel flat product and the Al coating.

16. The method according to claim 1, wherein before heating the steel flat product to the heat-treating temperature, the top layer applied onto the Zn layer contains at least one metal phosphate formed by a metal from the group consisting of Cu, Mo, Fe, Mn, Sb, Zn, Ti, Ni, Co, V, Mg, Bi, Be, Al, Ce, Ba, Sr Na K, Ge, Ga, Ca, Cr, In, and Sn.

17. The method according to claim 1, wherein the top layer is applied onto the Zn layer by spraying, by dipping, in a no-rinse process, by electrolytic deposition, or by vapour deposition.

18. The method according to claim 1, wherein the total thickness of the metallic coating present on the steel flat product before heating to the hot-forming temperature is 7-35 μm.

19. The method according to claim 1, wherein the finish-formed steel component has a base layer lying directly on the steel flat product, the base layer comprising of Al and additional contents of Fe, Zn and Si, an intermediate layer, the intermediate layer comprising of Zn and additional contents of Al, Si and Fe, and a top layer which comprising of amorphous phosphates or the thermal decomposition products thereof, wherein 0.1-45% wt. Zn is contained in the surface remote from the steel flat product as well as crystalline residual amounts of phosphates.

20. The method according to claim 19, wherein the base layer has at least 30% wt. Al, at least 20% wt. Fe, and at least 3% wt. Si.

21. The method according to claim 19, wherein the intermediate layer has at least 60% wt. Zn, at least 5% wt. Al, up to 10% wt. Fe, and up to 10% wt. Si.

22. The method according to claim 19, wherein the top layer comprises of amorphous and crystalline diphosphates, zinc oxide, aluminium oxide, or a combination thereof.

23. The method according to claim 19, wherein the thickness of the base layer is 15-35 μm, the thickness of the intermediate layer is 3-10 μm, and the thickness of the top layer is 0.01-10 μm.

24. The method according to claim 1, wherein the steel flat product is produced from a manganese boron steel.

25. A hot-formed steel component coated with a metallic coating which protects against corrosion, wherein the metallic coating is formed by a base layer lying on the steel flat product, an intermediate layer lying on the base layer, and a top layer lying on the intermediate layer, the base layer comprising at least 30% wt. Al, at least 20% wt. Fe, at least 3% wt. Si and at most 30% wt. Zn, the intermediate layer comprising at least 60% wt. Zn, at least 5% wt. Al, up to 10% wt. F; and up to 10% wt. Si, and the top layer comprising at least 8% wt. Zn, as well as ZnO, P and Al, wherein the P content is at most 1% wt. and the main constituent of the top layer is ZnO.

26. The steel component according to claim 25, wherein the thickness of the base layer is 10-50 μm, the thickness of the intermediate layer is 5-20 μm, and the thickness of the top layer is 0.01-10 μm.
